(19) United States
(12) Patent Application Publication
(10) Pub. No.: US 2010/0288668 A1
(43) Pub. Date: Nov. 18, 2010

(54) Decorative ice chest wrap

(76) Inventor: John Morris Aucoin, Slidell, LA (US)

Correspondence Address: John M Aucoin, 121 Tammy Dr, Slidell, LA, 70458, US

(21) Appl. No.: 12/454,245

(22) Filed: May 14, 2009

(51) Int. Cl. B65D 85/00; B23P 19/04

(52) U.S. Cl. 206/459.5; 29/700

(57) ABSTRACT

A graphic vinyl adhesive wrap for an ice chest and a method of creating and applying same.

### FIELD OF THE INVENTION

The present invention relates to decorative items used in connection with ice chests or other food and beverage storage items.

### BACKGROUND OF THE INVENTION

Ice chests or coolers are commonly used in a multitude of outdoor as well as indoor settings. Ice chests and coolers are frequently seen at picnics, tailgating, beaches, outdoor concerts and festivals. Companies, schools, and other entities are often sponsors of such events. These companies, schools, and other entities seek to place their logos on items at these events as a means of marketing, advertising, or demonstrating school pride.

Companies, schools, and other entities have attempted to personalize and customize ice chests by placing bumper stickers on the outer surfaces of ice chests, but this only provides a temporary and incomplete coverage of the ice chest with a graphic design or logo.

What is needed is a means of personalizing or customizing ice chests such that companies, schools, individuals, or others may place their names, logos, or other graphics onto the entire outer surfaces of ice chests such that these graphics may remain on the ice chests for longer periods of time and for multiple uses of the ice chests.

### BRIEF SUMMARY OF THE INVENTION

Accordingly, it is an object of this invention is to provide a method and device for wrapping an ice chest with a printed vinyl covering.

It is also an object of this invention to improve the outer appearance of ice chests through applying artwork, logos, designs, names, or other graphics.

### DETAILED DESCRIPTION OF THE INVENTION

The present invention relates to a decorative vinyl covering for an ice chest. In a preferred embodiment of the invention, the vinyl is a high tack, highly adhesive, white stock vinyl. In another embodiment of the invention, the vinyl is laminated to protect graphics in the vinyl.

The present invention further includes a method of wrapping an ice chest with a decorative vinyl covering, comprising the following steps:
a. obtaining an ice chest and measuring the ice chest;
b. cutting one or more vinyl adhesive sheets to fit the ice chest;
c. printing a graphic design onto the vinyl adhesive sheet;
d. heat treating the unwrapped ice chest;
e. placing the vinyl adhesive sheet(s) onto the ice chest and applying heat and pressure to ensure coverage of the ice chest;
f. trimming any excess vinyl from the cooler.

In another embodiment of this invention, the method steps include laminating the one or more vinyl adhesive sheets to protect the graphics on the wrap and preserve its appearance.

What is claimed is:

1. An ice chest wrap comprising a vinyl sheet that is printed with graphics.

2. An ice chest wrap comprising a laminated vinyl sheet that is printed with graphics.

3. An ice chest wrap comprising a vinyl sheet.

4. A method of wrapping an ice chest comprising:
a. obtaining an ice chest and measuring the ice chest;
b. cutting one or more vinyl adhesive sheets to fit the ice chest;
c. printing a graphic design onto the one or more vinyl adhesive sheets;
d. heat treating the unwrapped ice chest;
e. placing the one or more vinyl adhesive sheets onto the ice chest;
f. applying heat and pressure to the one or more vinyl adhesive sheets to ensure coverage of the ice chest; and
g. trimming any excess vinyl from the cooler.

5. A method of wrapping an ice chest comprising:
a. obtaining an ice chest and measuring the ice chest;
b. cutting one or more vinyl adhesive sheets to fit the ice chest;
c. printing a graphic design onto the one or more vinyl adhesive sheets;
d. laminating the one or more vinyl adhesive sheets;
e. heat treating the unwrapped ice chest;
f. placing the one or more vinyl adhesive sheets onto the ice chest
g. applying heat and pressure to the one or more vinyl adhesive sheets to ensure coverage of the ice chest; and
h. trimming any excess vinyl from the cooler.
